(19) United States
(12) Patent Application Publication
(10) Pub. No.: US 2009/0290539 A1
(43) Pub. Date: Nov. 26, 2009

(54) Method and apparatus for home agent address acquisition for IPv4 mobile nodes

(75) Inventors: Yangsong Xia, Nanjing (CN); Behcet Sarikaya, Wylie, TX (US)

Correspondence Address: Slater & Matsil, L.L.P., 17950 Preston Road, Suite 1000, Dallas, TX, 75252, US

(73) Assignee: Huawei Technologies, Co., Ltd., Plano, TX (US)

(21) Appl. No.: 12/466,301

(22) Filed: May 14, 2009

Related U.S. Application Data
(60) Provisional application No. 61/055,036, filed on May 21, 2008.

(51) Int. Cl. H04W 80/00

(52) U.S. Cl. 370/328

(57) ABSTRACT

A method and apparatus for home agent address acquisition for IPv4 mobile nodes is provided. A method for device operation includes sending a request message to an authentication, authorization, and accounting (AAA) server, and receiving a reply message from the AAA server. The reply message contains an assigned Internet Protocol version 4 (IPv4) address of a home agent and the home agent is deployed with a dual stack mobile Internet Protocol version 6 (IPv6) function.

This application claims the benefit of U.S. Provisional Application No. 61/055,036, filed on May 21, 2008, entitled “AAA Interface of Mobile IPv6 for Dual Stack Hosts and Routers (DSMIPv6),” which application is hereby incorporated herein by reference.

### TECHNICAL FIELD

The present invention relates generally to communications, and more particularly to a method and apparatus for home agent address acquisition for Internet Protocol version 4 (IPv4) mobile nodes.

### BACKGROUND

Due to overwhelming popularity of the Internet, Internet Protocol, Version 4 (IPv4), the first publicly used Internet Protocol is rapidly running out of addressing capacity. With an address space of 2³² addresses (about 4 billion in all), IPv4 is expected to run out of addressing capacity in the early 21^{st} century. Internet Protocol, Version 6 (IPv6) has emerged as a successor to IPv4. However, after almost a decade since being selected as successor to IPv4, IPv6 still accounts for less than one percent of total Internet traffic. Therefore, in the near term, it is expected that both IPv4 and IPv6 traffic will remain comingled.

Mobile IPv6 (MIPv6) is an implementation of IPv6 that supports the exchange of data in a packet switched internetwork. MIPv6 allows an IPv6 node to be mobile, i.e., arbitrarily move about an IPv6 network while maintaining existing connections as well as reachability using an IPv6 address or prefix. FIG. 1 illustrates an internetwork 100. Internetwork 100 includes a mobile node (MN) 105 that communicates to a host 110, for example. Communications between MN 105 and host 110 go through a home agent (HA) 115. All traffic to and from MN 105 should go through HA 115. MN 105 registers its current location, e.g., its IP address (its Care-of Address), with HA 115. However, prior to providing HA 115 with its own IP address, MN 105 may need to obtain the IP address of HA 115.

As MN 105 moves around, it may connect to HA 115 through an access router, such as AR1 120. AR1 120 may allow MN 105 to connect to HA 115 by way of a visited network 125, the Internet 130, and a home network 135 (where HA 115 is located). As MN 105 continues to move, it may move outside of a coverage area of AR1 120 and move into a coverage area of AR2 122. When MN 105 changes access routers (from AR1 120 to AR2 122), the IP addresses of MN 105 (the Care-of Address). In order to retain its existing connections, MN 105 must update its location, e.g., its new IP address, with HA 115.

FIG. 2a illustrates IP address acquisition through an AAA server. MN 105 may request the IP address of HA 115 from an AAA server 205 via a connection through AR1 120 and intermediary networks, such as visited network 125 and Internet 130. MN 105 and AAA server 205 may utilize Radius, Diameter, or so forth, message exchanges to provide the IP address of HA 115 to MN 105. Once provided with the IP address of HA 115, MN 105 may inform HA 115 of its new IP address.

FIG. 2b illustrates IP address acquisition through a Dynamic Host Configuration Protocol (DHCP) server. MN 105 may request the IP address of HA 115 from a DHCP server 210 via a connection through AR1 120 and intermediary networks, such as visited network 125 and Internet 130. MN 105 and DHCP server 210 may utilize DHCP message exchanges to provide the IP address of HA 115 to MN 105. Once provided with the IP address of HA 115, MN 105 may inform HA 115 of its new IP address.

Although FIGS. 2a and 2b illustrate a direct connection between MN 105 and AAA server 205 or DHCP server 210, in actual practice, an intermediary device may be present between MN 105 and AAA server 205 or DHCP server 210. The intermediary device may function as an AAA client network access server (NAS), a DHCP relay, or both. The intermediary device may allow the MN 105 to communicate with AAA server 205 or DHCP server 210, where direct communications may be prohibited.

As discussed previously, IPv6 traffic accounts for less than one percent of total Internet traffic, therefore, if only IPv6 IP addresses are supported, then incompatibilities with network equipment may be encountered due to inherent incompatibilities between IPv4 and IPv6. Therefore, in order to maximize compatibility, both IPv6 and IPv4 IP addresses and functionality should be supported and used as needed.

Mobile IPv6 Bootstrapping is defined as obtaining enough information at the MN so that the MN can successfully register with an appropriate HA. Specifically, this means obtaining the IP address of the HA as well as the home address. Additionally, the MN and the HA need to authenticate and mutually construct security credentials for Mobile IPv6. Radius and Diameter interfaces for Mobile IPv6 Bootstrapping have been described for IPv6 only. Therefore, what is needed are Radius and Diameter interfaces for Mobile IPv6 Bootstrapping for IPv4.

### SUMMARY OF THE INVENTION

These and other problems are generally solved or circumvented, and technical advantages are generally achieved, by embodiments of a method and apparatus for home agent address acquisition for Internet Protocol version 4 (IPv4) mobile nodes.

In accordance with an embodiment, a method for device operation is provided. The method includes sending a request message to a server, and receiving a reply message from the server. The reply message contains an assigned Internet Protocol version 4 (IPv4) address of a home agent. The server includes an authentication, authorization, and accounting (AAA) server, and the home agent is deployed with a dual stack mobile Internet Protocol version 6 (IPv6) function.

In accordance with another embodiment, a method for mobile device operation is provided. The method includes sending a request message, and receiving a reply message from a Dynamic Host Configuration Protocol version 4 (DHCPv4) server. The request message contains a request for an address of a home agent, and the reply message contains an assigned Internet Protocol address of the home agent. The mobile device is deployed with a dual stack mobile Internet Protocol version 6 (IPv6) function.

In accordance with another embodiment, an apparatus is provided. The apparatus includes means for sending a request message to a server, and means for receiving a reply message from the server. The reply message contains an assigned Internet Protocol version 4 (IPv4) address of a home agent, and the server comprises an authentication, authorization, and accounting (AAA) server. The home agent is deployed with a dual stack mobile Internet Protocol version 6 (IPv6) function.

An advantage of an embodiment is that both IPv4 and IPv6 IP addresses are supported, which may help to increase compatibility with a larger number of network devices.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of an internetwork;

FIG. 2a is a diagram of IP address acquisition through an AAA server;

FIG. 2b is a diagram of IP address acquisition through a Dynamic Host Configuration Protocol (DHCP) server;

FIG. 3 is a diagram of a message exchange in obtaining an IP address of a HA through a DHCPv6 server, wherein an access service authorizer (ASA) and a mobility service authorizer (MSA) are integrated (or implemented) in a single entity;

FIG. 4 is a diagram of a message exchange in obtaining an IP address of a HA through a DHCPv6 server, wherein an access service authorizer (ASA) and a mobility service authorizer (MSA) are separate entities;

FIG. 5 is a diagram of a message exchange in obtaining an IP address of a HA through a DHCPv4 server;

FIG. 6a is a flow diagram of AAA client NAS/DHCPv4 relay operations in obtaining an IP address of a HA, wherein the IP address is provided by a DHCPv4 server;

FIG. 6b is a flow diagram of AAA client NAS/DHCPv4 relay operations in obtaining an IP address of a HA, wherein the IP address is provided by a home AAA server;

FIG. 7a is a flow diagram of mobile node operations in obtaining an IP address of a HA, wherein the IP address is provided by a DHCPv4 server; and

FIG. 7b is a flow diagram of mobile node operations in obtaining an IP address of a HA, wherein the IP address is provided by a home AAA server.

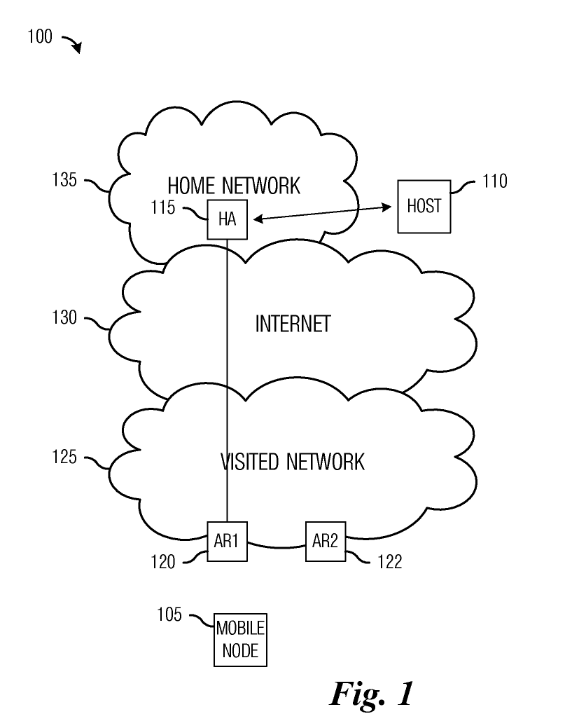

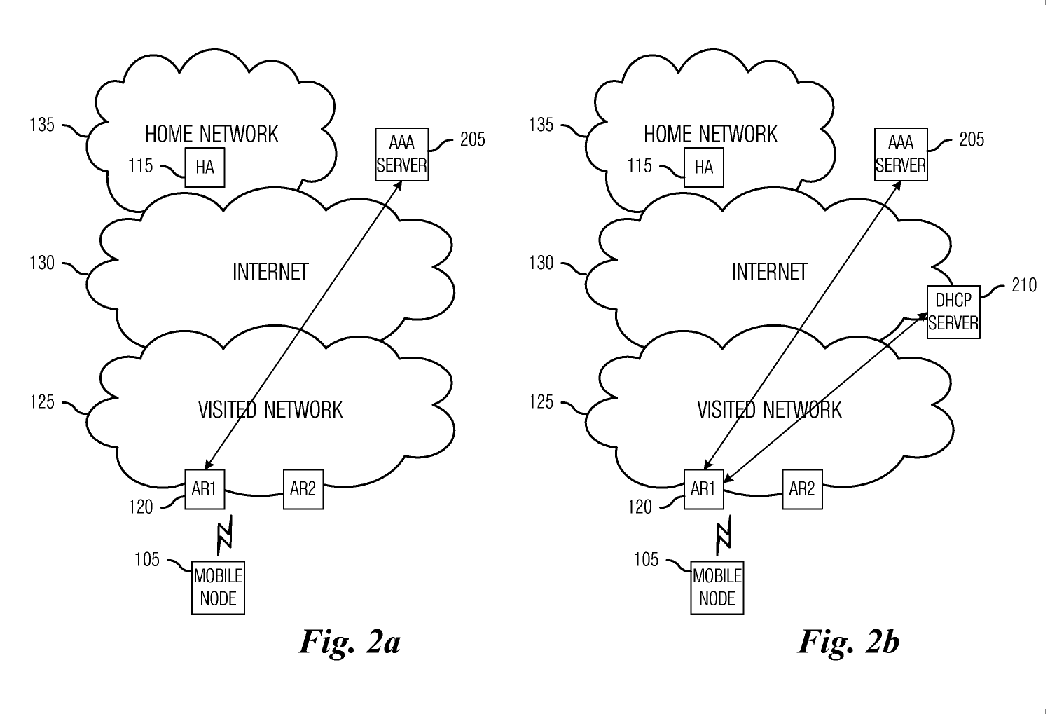

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a mobile node communicating through a network using dual stack mobile IPv6 (DSMIPv6) and either Radius or Diameter authentication protocol.

Mobile IPv6 Bootstrapping has been defined for IPv6 IP addresses only. Two different deployment scenarios may occur: a split scenario and an integrated scenario. In the split scenario, mobility service and network access service are authorized by different entities, while in the integrated scenario, the two services are authorized by the same entity.

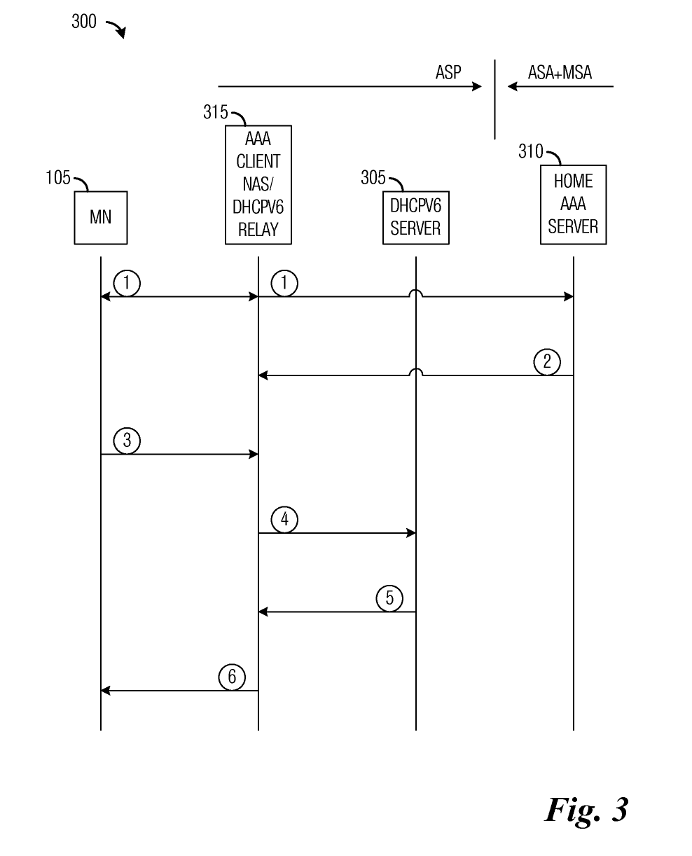

FIG. 3 illustrates a message exchange 300 in obtaining an IP address of HA 115 through a Dynamic Host Configuration Protocol IPv6 (DHCPv6) server, wherein an access service authorizer (ASA) and a mobility service authorizer (MSA) are integrated (or implemented) in a single entity (an integrated scenario). As shown in FIG. 3, messages may be exchanged between MN 105, a DHCPv6 server 305, a home AAA server 310, and an AAA client NAS/DHCPv6 relay 315. Message exchange 300 illustrates the obtaining of an IP address of HA 115 using Radius protocol. A similar message exchange exist using Diameter protocol, with different message formats.

The obtaining of an IP address of HA 115 may begin with MN 105 executing a normal network access authentication procedure, such as IEEE 802.11i/802.1x, or Protocol for carrying Authentication for Network Access (PANA), with AAA client NAS/DHCPv6 relay 315 (transmission numbered one (1)). If AAA client NAS/DHCPv6 relay 315 indicates support for local home agent assignment, then AAA client NAS/DHCPv6 relay 315 may include DSMIP6-HA Attributes as a proposal to home AAA server 310 of HA 115 to assign in an access service provider (ASP) (also transmission numbered one (1)).

The DSMIP6-HA Attribute may be sent by AAA client NAS/DHCPv6 relay 315 (a NAS) to home AAA server 310 (a Radius server) in an Access-Request packet as a proposal to allocate a local HA to a MN. Alternatively, the DSMIP6-HA Attribute may be sent by home AAA server 310 to AAA client NAS/DHCPv6 relay 315 in an Access-Accept packet. In this situation, the DSMIP6-HA Attribute carries the IP address of the HA to the MN. The DSMIP6-HA Attribute may have the following format:

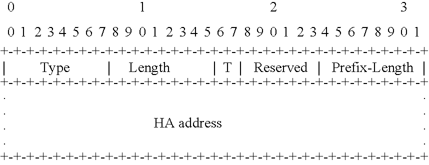

Type:
to be defined by IANA.
Length:
The length of the attribute.
T bits:
The type of address. It has the following meaning:
01 the home agent has IPv4 address
11 the home agent has IPv6 address
Reserved:
Reserved for future use.
Prefix-Length:
When T field is 01, this field should be ignored.
When T field is 11, this field defines the prefix length of
the following IPv6 address.
HA address:
IPv4 or IPv6 HA address.

Additional attributes include DSMIP6-HOA Attribute and DSMIP6-Careof-Address. The DSMIP6-HOA Attribute may be sent by home AAA server 310 (a Radius server) to an HA (such as HA 115) in an Access-Accept packet. The DSMIP6-HOA Attribute carries the assigned home IPv6 or IPv4 Address for a MN (such as MN 105). Additionally, the DSMIP6-HOA Attribute may be sent by HA 115 to home AAA server 310 in an Access-Request packet as a hint to suggest a home address that may be assigned to MN 105. Home AAA server 310 may be required to use the suggested home address if it accepts the suggestion from HA 115. If available at HA 115, the DSMIP6-HOA Attribute should appear in accounting packets so that the IPv6 or IPv4 address used for this session is known in the accounting stream. The DSMIP6-HOA Attribute may have the following format:

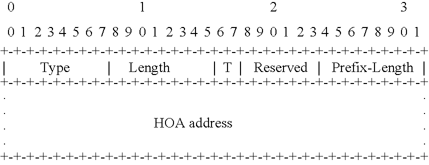

Type:
to be defined by IANA.
Length:
The length of the attribute.
T bits:
The type of address. It has the following meaning:
01 the MN's home address is IPv4
11 the MN's home address is IPv6
Reserved:
Reserved for future use.
Prefix-Length:
When T field is 01, this field should be ignored.
When T field is 11, this field defines the prefix length of
the following IPv6 address.
HOA address:
IPv4 or IPv6 HOA address.

The DSMIP6-Careof-Address Attribute may be sent by a HA (such as HA 115) to a Radius server (such as home AAA server 310). The care-of-address of a MN may be used by the HA to transmit accounting information to a home AAA server, for example. The DSMIP6-Careof-Address Attribute is the IPv6 or IPv4 address of the care-of-address of a MN extracted from a Binding Update (BU) message. The DSMIP6-Careof-Address Attribute may have the following format:

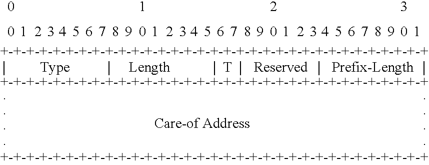

Type:
to be defined by IANA.
Length:
The length of the attribute.
T bits:
The type of address. It has the following meaning:
01 the MN's care of address is IPv4
11 the MN's care of address is IPv6
Reserved:
Reserved for future use.
Prefix-Length:
When T field is 01, this field should be ignored.
When T field is 11, this field defines the prefix length of
the following IPv6 address.
Care-of address:
IPv4 or IPv6 Care-of address.

Home AAA server 310 may respond by sending an Access-Accept packet with a MIP6-Feature-Vector defined with a Local Home Agent Assignment flag set or cleared (transmission numbered two (2)). If the Local Home Agent Assignment flag is cleared, then home AAA server 310 may need to provide one or more HA(s) to be assigned to MN 105. If the Local Home Agent Assignment flag is set, then it indicates to AAA client NAS/DHCPv6 relay 315 that it may assign a HA to MN 105. Furthermore, home AAA server 310 may also include one or more HA IP addresses thus indicating that AAA client NAS/DHCPv6 relay 315 can either allocate a local HA or one specified by home AAA server 310.

MN 105 may send a DHCPv6 Information Request message to all DHCP relay agents (such as AAA client NAS/DHCPv6 relay 315) and DHCP servers (such as DHCPv6 server 305) (transmission numbered three (3)). The DHCPv6 Information Request message may include a Home Network Identifier Option, wherein the Home Network Identifier Option may be used for a request to discover home network information that pertains to a given realm, i.e., a user's home domain (identified by a Network Access Identifier (NAI) of a MN, for example). An OPTION_CLIENTID may be set by MN 105 to identify itself to DHCPv6 server 305.

AAA client NAS/DHCPv6 relay 315 may forward the DHCPv6 Information Request message to DHCPv6 server 305 (transmission numbered four (4)). The DHCPv6 Information Request message to DHCPv6 server 305 may include MIP6 Relay Agent Option. The MIP6 Relay Agent Option may convey information extracted from DSMIP6-HA Attribute in the Access-Accept packet.

DHCPv6 server 305 identifies the client (by DHCP Unique Identifier (DUID)) and determines that the client requests HA information in the MSP (by the Home Network Identifier Option=1). DHCPv6 server 305 extracts the IP address of HA 115 from MIP6 Relay Agent Option and places it into Home Network Information Option in a Reply message sent to AAA client NAS/DHCPv6 relay 315 (transmission numbered five (5)). AAA client NAS/DHCPv6 relay 315 may then forward the Reply message to MN 105 (transmission numbered six (6)). When MN 105 receives the Reply message from AAA client NAS/DHCPv6 relay 315, MN 105 has access to the IP address of HA 115. The obtaining of an IP address of HA 115 may then terminate.

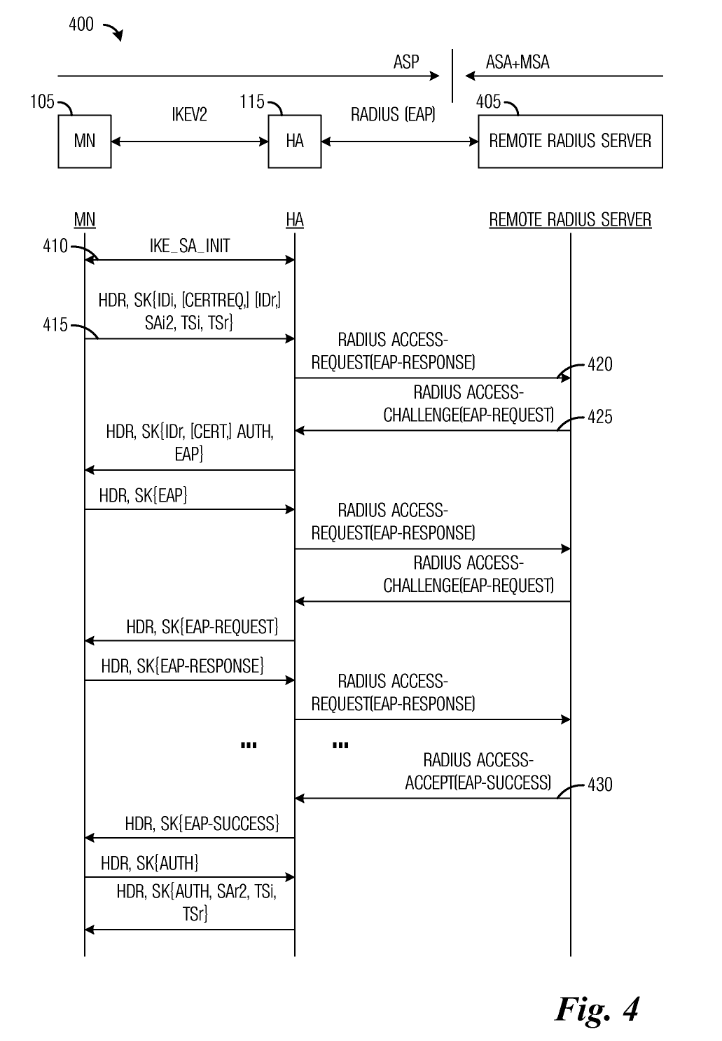

FIG. 4 illustrates a message exchange 400 in obtaining an IP address of HA 115 through a Dynamic Host Configuration Protocol IPv6 (DHCPv6) server, wherein an access service authorizer (ASA) and a mobility service authorizer (MSA) are different entities (a split scenario). As shown in FIG. 4, messages may be exchanged between MN 105, HA 115, and a remote Radius server 405. Message exchange 400 illustrates the obtaining of an IP address of HA 115 using Radius protocol. A similar message exchange exist using Diameter protocol, with different message formats.

MN 105 may be able to acquire the IP address of HA 115 through a Domain Name Server (DNS) lookup. MN 105 may then use an Internet Key Exchange (IKE or IKEv2) with HA 115 to set up an Internet Protocol Security (IPsec) Security Association (SA). As part of the set up of the IPsec SA, MN 105 may authenticate itself to remote Radius server 405 in the MSA domain and obtain authorization for mobility service, which also includes the IP address of HA 115.

MN 105 and HA 115 may start with an IKE_SA_INIT message 410 to setup the IKE SA. The messages used are as defined in the IKEv2 specifications. Operations include negotiating cryptography algorithms and running a Diffie-Hellman (DH) key exchange, for example. IKEv2 supports integration with Extensible Authentication Protocol (EAP). MN 105 may indicate its desire to use EAP by not including an AUTH payload in message 415. However, it indicates its identity (NAI) by using the IDi field in message 415.

If HA 115 supports EAP for authentication, it forwards the identity to remote RADIUS server 405 by sending a RADIUS Access-Request packet (message 420) containing the identity in an EAP-Payload AVP and in a RADIUS User-Name attribute. Based on this identity, remote RADIUS server 405 chooses an authentication method and sends the first EAP-Request in a RADIUS Access-Challenge packet (message 425). During the EAP authentication phase, HA 115 relays EAP packets between MN 105 and remote RADIUS server 405.

If the authentication succeeds and if MN 105 is authorized to use Mobile IPv6 service, remote RADIUS server 405 sends a RADIUS Access-Accept packet containing an EAP-Success and an AAA-Key derived from the EAP authentication method (message 430). The key may be used by both MN 105 and HA 115 to generate the AUTH payload. In subsequent messages, MN 105 and HA 115 set up IPsec SAs for Mobile IPv6. The obtaining of an IP address of HA 115 may then terminate.

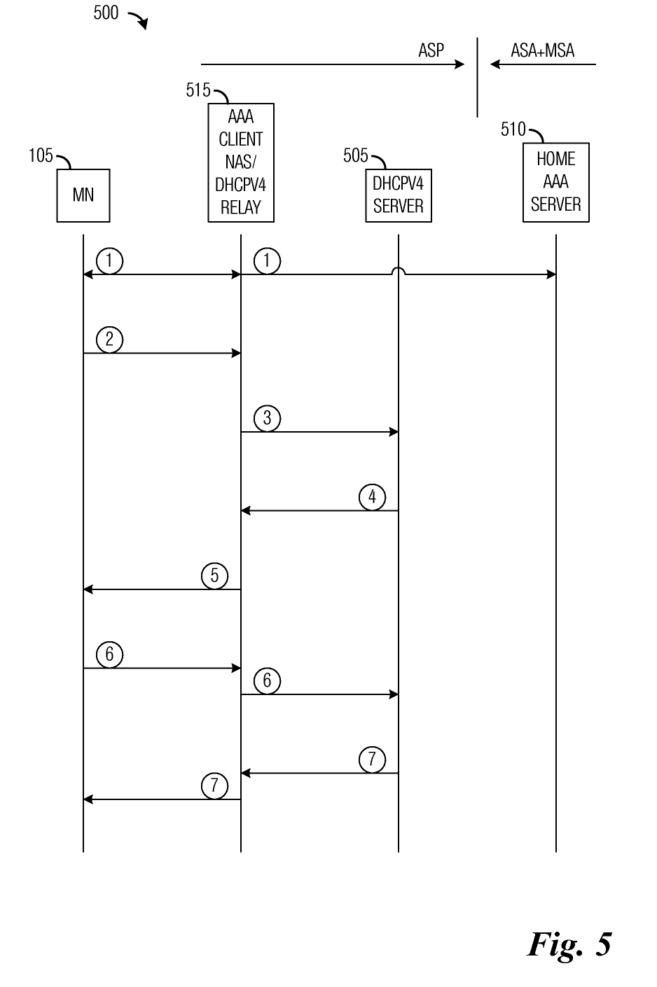

FIG. 5 illustrates a message exchange 500 in obtaining an IP address of HA 115 through a DHCPv4 server. Message exchange 500 illustrates the obtaining of an IP address of HA 115 using Radius protocol. A similar message exchange exists using Diameter protocol, with different message formats.

The obtaining of an IP address of HA 115 may begin with MN 105 executing a normal network access authentication procedure, such as IEEE 802.11i/802.1x, or PANA, with AAA client NAS/DHCPv4 relay 515 (transmission numbered one (1)). The normal network access authentication procedure may involve the creation of a message and then transmitting the message. If AAA client NAS/DHCPv4 relay 515 indicates support for local home agent assignment, then AAA client NAS/DHCPv4 relay 515 may include DSMIP6-HA Attributes as a proposal to home AAA server 510 of HA 115 to assign in an ASP (also transmission numbered one (1)).

Home AAA server 510 may send an Access-Accept packet with a MIP6-Feature-Vector with the Local Home Agent Assignment flag set or cleared. If the Local Home Agent Assignment flag is cleared then home AAA server 510 may need to provide one or more HA(s) to be assigned to MN 105. If the Local Home Agent Assignment flag is set then the Local Home Agent Assignment flag indicates to AAA client NAS/DHCPv4 relay 515 that it can assign a HA to MN 105. Home AAA server 510 may also include one or more HA addresses, thus indicating that AAA client NAS/DHCPv4 relay 515 can either assign a local HA or one specified by home AAA server 510.

MN 105, operating as a DHCPv4 client, may broadcast a DHCPDISCOVER message on its local physical subnet (transmission numbered two (2)). The DHCPDISCOVER message may include a DHCPv4 Home Network Identifier Option, which may be used for a request to discover home network information that pertains to a given realm, i.e., the user's home domain (as identified by a NAI of MN 105, for example).

AAA client NAS/DHCPv4 relay 515 may forward the DHCPDISCOVER message to DHCPv4 server 505 (transmission numbered three (3)). The forwarded DHCPDISCOVER message may include a DHCPv4 DSMIP6 Relay Agent Option, which carries information extracted from a Radius DSMIP6-HA Attribute in the Access-Accept packet.

DHCPv4 server 505 may identify the client (by DUID) and determines that it requests HA information in the MSP (e.g., by the DHCPv4 Home Network Identifier Option=1). DHCPv4 server 505 may extract the HA information from DHCPv4 DSMIP6 Relay Option and place it into DHCPv4 Home Network Information Option in a DHCPOFFER message (transmission numbered four (4)). AAA client NAS/DHCPv4 relay 515 may forward the DHCPOFFER message to MN 105 (transmission numbered five (5)). The forwarded DHCPOFFER message may include the DHCPv4 Home Network Information Option.

The DHCPv4 Home Network Information Option may allow for the exchange of home network information between the MN (DHCPv4 client) and a DHCPv4 server. It may be used to indicate a target home network requested by the MN to the DHCPv4 server in the DHCPDISCOVER or DHCPREQUEST message. In a DHCPOFFER or DHCPPACK message, it may be used to convey home network information assigned by the DHCPv4 server to the MN. The DHCPv4 Home Network Information Option may have the following format:

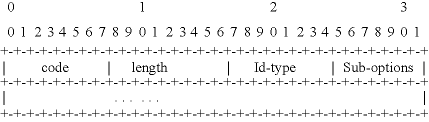

code
TBD by INA
length
length of Id-type + Sub-options in units of octets.
Id-type
The type of Home Network Information.
0 Visited domain (local ASP)
1 Target MSP
2 No preference by the mobile node
Sub-options
A series of sub-options as specified below.

DHCPv4 DSMIP6 Relay Agent Option: This option carries the home network information for the MN from a AAA client NAS/DHCPv4 relay (such as AAA client NAS/DHCPv4 relay 515) to the DHCPv4 server. The AAA client NAS/DHCPv4 relay sends this option to the DHCPv4 server. The DHCPv4 DSMIP6 Relay Agent Option may have the following format:

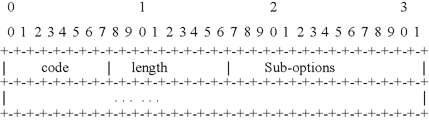

code
TBD by INA
length
length of Sub-options in units of octets.
Sub-options
A series of sub-options as specified below.

This sub-option may be a container for a home network parameter in the DHCPv4 Home Network Information option or in the DHCPv4 DSMIP6 Relay Agent option. It may have the following format:

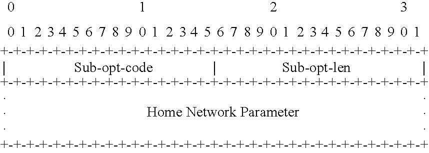

Sub-opt-code
A 16-bit unsigned integer for the type of the following
Home Network Parameter field. Possible values are:
0 Reserved
1 Home network identifier (only admitted
in a DHCPv4 Home Network Information option)
2 IPv6 home network prefix
3 IPv6 home agent address
4 IPv4 address of the IPv6 home agent
5 Home agent FQDN
6 . . (2\hat{ }16-1) Reserved
Sub-opt-len
The length of the Home Network Parameter field in units
of octets.
Home Network Parameter
The provided home network information according to the
Sub-opt-code.

Referring back to FIG. 5, MN 105, as a DHCP client, may broadcast a DHCPREQUEST message to indicate which DHCP server it has selected and to verify configuration information received from DHCPv4 server 505 (transmission numbered six (6)). Included in the DHCPREQUEST message may be DHCPv4 Home Network Identifier Option, along with assigned information from previous DHCPDISCOVER/DHCPOFFER message exchange. MN 105 may receive and store a DHCPPACK message from DHCPv4 server 505 and forwarded by AAA client NAS/DHCPv4 relay 515 containing home network information included in DHCPv4 Home Network Identifier Option (transmission numbered seven (7)). The obtaining of an IP address of HA 115 may then terminate.

The previous discussion focused on obtaining an IP address of a HA using Radius protocol. It may also be possible to use Diameter protocol and a Diameter server to obtain an IP address of a HA. Extensions to Diameter Attribute-Value Pairs (AVP) include:

MIP-Home-Agent-Address AVP: The MIP-Home-Agent-Address AVP (AVP Code 334) is of type Address and contains the IPv6 OR IPv4 address of a HA. The HA address is the same as in the received BU message that triggers the authentication and authorization procedure towards the Diameter server. Type Address is as defined in Calhoun, P., Loughney, J., Guttman, E., Zorn, G., and J. Arkko, “Diameter Base Protocol”, RFC 3588, September 2003. The first two octets of the Address AVP represent the AddressType, which contains an Address Family defined by Internet Assigned Numbers Authority (IANA). In DSMIPv6 scenario, if the HA's address is IPv4, the value of AddressType is 1; and if the HA's address is IPv6, the value of AddressType is 2.

MIP-Mobile-Node-Address AVP: The MIP-Mobile-Node-Address AVP (AVP Code 333) is of type Address and contains the HA assigned IPv6 OR IPv4 Home Address of the MN. In DSMIPv6 scenario, if the HoA of the MN is IPv4, the value of AddressType is 1; and if the HoA of the MN is IPv6, the value of AddressType is 2. If the MIP-Mobile-Node-Address AVP contains an unspecified address (IPv4 or IPv6) in a request message (e.g. Diameter-EAP-Request), then the HA expects the Diameter server to assign the HoA in a subsequent reply message. If the MIP-Mobile-Node-Address AVP contains a specified address (IPv4 or IPv6) in a request message (e.g. Diameter-EAP-Request), then the HA expects the Diameter server to approve the use of the address. If the Diameter server grants the use of the address, the server sends a reply message (e.g. Diameter-EAP-Answer) including a MIP-Mobile-Node-Address AVP whose value is the specified address. Otherwise, the Diameter server should allocate another address.

MIP-Careof-Address AVP: The MIP-Careof-Address AVP (AVP Code To Be Determined) is of type Address and contains the IPv6 OR IPv4 Care-of Address of the MN. The HA extracts this IP address from the received BU message. This AVP may be included in the Accounting-Request (ACR) message.

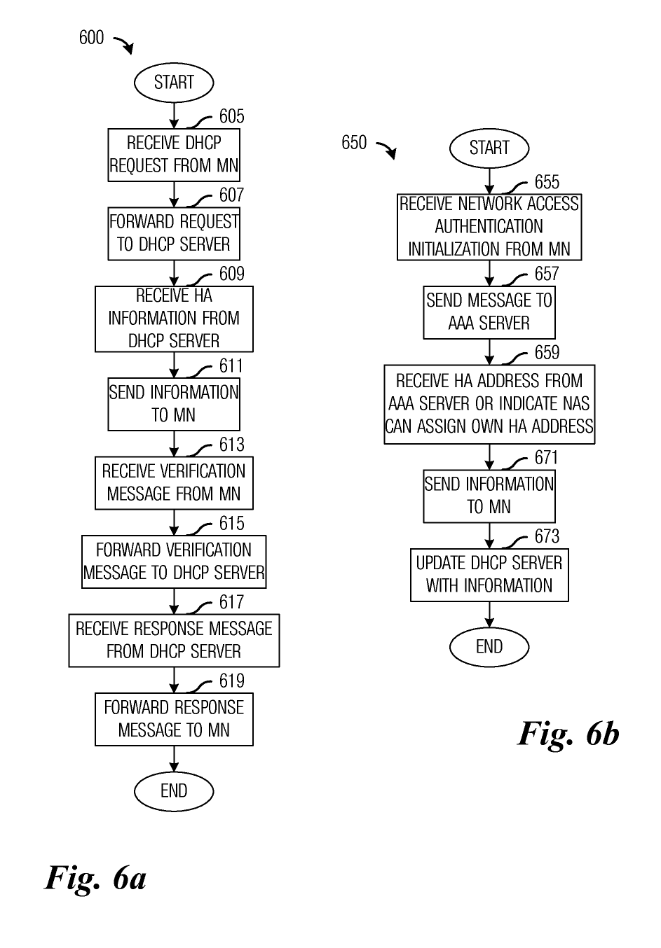

FIG. 6a illustrates a flow diagram of AAA client NAS/DHCPv4 relay operations 600 in obtaining an IP address of a HA, wherein the IP address is provided by a DHCPv4 server. AAA client NAS/DHCPv4 relay operations 600 may be indicative of operations taking place at a AAA client NAS/DHCPv4 relay whenever a MN changes its access router due to its mobility and must register with its HA. Part of the registration process requires that the MN find the IP address of its HA.

AAA client NAS/DHCPv4 relay operations 600 may begin when an AAA client NAS/DHCPv4 relay, such as AAA client NAS/DHCPv4 relay 515 (shown in FIG. 5) receives a DHCP request from a MN, such as MN 105 (block 605). According to an embodiment, MN 105 may broadcast a DHCPDISCOVER message on its local physical subnet, where the DHCPDISCOVER message includes a DHCPv4 Home Network Identifier Option, which may be used as a request to discover home network information that pertains to a given realm, i.e., the user's home domain.

AAA client NAS/DHCPv4 relay 515 may forward the DHCPDISCOVER message from MN 105 to a DHCPv4 server, such as DHCPv4 server 505 (block 609). The forwarded DHCPDISCOVER message may include a DHCPv4 DSMIP6 Relay Agent Option, which carries information extracted from a Radius DSMIP6-HA Attribute carried in an Access-Accepted packet also received by AAA client NAS/DHCPv4 relay 515.

AAA client NAS/DHCPv4 relay 515 may receive HA information, which includes the IP address of the HA (block 609). AAA client NAS/DHCPv4 relay 515 may receive a DHCPOFFER message from DHCPv4 server 505 containing HA information, which DHCPv4 server 505 extracted from DHCPv4 DSMIP6 Relay Option. AAA client NAS/DHCPv4 relay 515 may forward the DHCPOFFER message on to MN 105 (block 611). AAA client NAS/DHCPv4 relay operations 600 may then terminate.

FIG. 6b illustrates a flow diagram of AAA client NAS/DHCPv4 relay operations 650 in obtaining an IP address of a HA, wherein the IP address is provided by a home AAA server. AAA client NAS/DHCPv4 relay operations 650 may be indicative of operations taking place at a AAA client NAS/DHCPv4 relay whenever a MN changes its access router due to its mobility and must register with its HA. Part of the registration process requires that the MN find the IP address of its HA.

AAA client NAS/DHCPv4 relay operations 600 may begin when an AAA client NAS/DHCPv4 relay, such as AAA client NAS/DHCPv4 relay 515, receives a network access authentication initialization from a MN, such as MN 105 (block 655). MN 105 may initiate a normal network access authentication procedure, such as IEEE 802.11i/802.1x, or PANA, by exchanging messages with AAA client NAS/DHCPv4 relay 515. AAA client NAS/DHCPv4 relay 515 may indicate that it supports local home agent assignment and transmit a message to a home AAA server, such as home AAA server 510 (block 657). The message transmitted to home AAA server 510 may include DSMIP6-HA Attributes set to be a proposal to home AAA server 510 of an HA, such as HA 115, to assign in an ASP.

Home AAA server 510 may send a message to AAA client NAS/DHCPv4 relay 515 with either an HA address or an indication that AAA client NAS/DHCPv4 relay 515 may assign its own local HA to MN 105 (block 659). The message may be in the form of an Access-Accept packet with a MIP6-Feature-Vector with the Local Home Agent Assignment flag set or cleared. If the Local Home Agent Assignment flag is cleared then home AAA server 510 may need to provide one or more HA(s) to be assigned to MN 105. If the Local Home Agent Assignment flag is set then the Local Home Agent Assignment flag indicates to AAA client NAS/DHCPv4 relay 515 that it can assign a HA to MN 105. Home AAA server 510 may also include one or more HA addresses, thus indicating that AAA client NAS/DHCPv4 relay 515 can either assign a local HA or one specified by home AAA server 510.

AAA client NAS/DHCPv4 relay 515 may either send the HA address provided by home AAA server 510, an HA address of its own choosing, or an HA address suggested by home AAA server 510 to MN 105 (block 671). The HA address provided by AAA client NAS/DHCPv4 relay 515 may be dependent on factors such as the Local Home Agent Assignment flag, a local HA available to AAA client NAS/DHCPv4 relay 515, and so forth. AAA client NAS/DHCPv4 relay 515 may also send a message to a DHCPv4 server, such as DHCPv4 server 505, with the message containing the HA address that AAA client NAS/DHCPv4 relay 515 had sent to MN 105 (block 673). AAA client NAS/DHCPv4 relay operations 650 may then terminate.

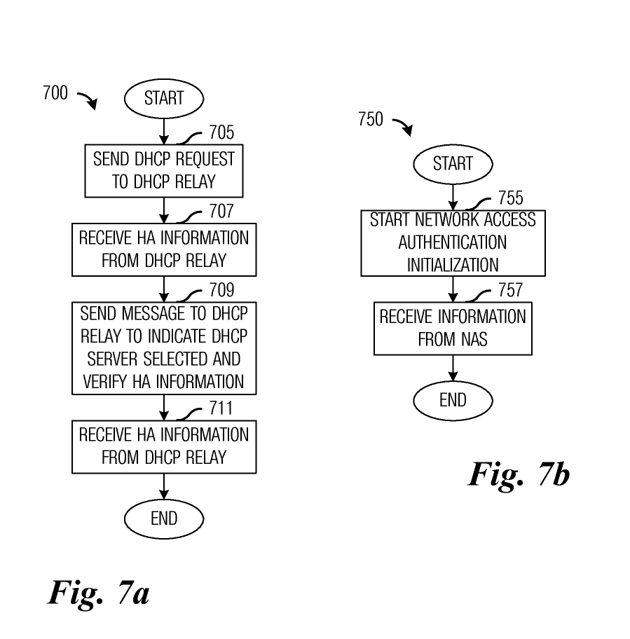

FIG. 7a illustrates a flow diagram of MN operations 700 in obtaining an IP address of a HA, wherein the IP address is provided by a DHCPv4 server. MN operations 700 may be indicative of operations taking place at a MN whenever the MN changes its access router due to its mobility and must register with its HA. Part of the registration process requires that the MN find the IP address of its HA.

MN operations 700 may begin with an MN, such as MN 105, sending a DHCP request to an AAA client NAS/DHCPv4 relay, such as AAA client NAS/DHCPv4 relay 515 (block 705). MN 105, operating as a DHCPv4 client, may broadcast a DHCPDISCOVER message on its local physical subnet. The DHCPDISCOVER message may include a DHCPv4 Home Network Identifier Option, which may be used for a request to discover home network information that pertains to a given realm, i.e., the user's home domain.

MN 105 may receive HA information from AAA client NAS/DHCPv4 relay 515 (block 707). AAA client NAS/DHCPv4 relay 515 may forward to MN 105 a DHCPOFFER message from a DHCPv4 server, such as DCHPv4 server 505. The DCHPOFFER message may contain HA information from a DHCPv4 DSMIP6 Relay Option extracted by DCHPv4 server 505 and placed into a DHCPv4 Home Network Information Option in the DHCPOFFER message. The forwarded DHCPOFFER message may also include the DHCPv4 Home Network Information Option.

MN 105, as a DHCP client, may send a message to DHCPv4 servers, including DHCPv4 server 505 (block 709). The message may include a DHCPREQUEST message to indicate which DHCP server it has selected and to verify configuration information received from DHCPv4 server 505. Included in the DHCPREQUEST message may be DHCPv4 Home Network Identifier Option, along with assigned information from previous DHCPDISCOVER/DHCPOFFER message exchange.

MN 105 may receive a DHCPPACK message from DHCPv4 server 505 (forwarded by AAA client NAS/DHCPv4 relay 515) containing home network information included in DHCPv4 Home Network Identifier Option (block 711). MN operations 700 may then terminate.

FIG. 7b illustrates a flow diagram of MN operations 750 in obtaining an IP address of a HA, wherein the IP address is provided by a home AAA server. MN operations 750 may be indicative of operations taking place at a MN whenever the MN changes its access router due to its mobility and must register with its HA. Part of the registration process requires that the MN find the IP address of its HA.

MN operations 750 may begin with an MN, such as MN 105, initiates a network access authentication initialization with an AAA client NAS/DHCPv4 relay, such as AAA client NAS/DHCPv4 relay 515 (block 755). MN 105 may initiate a normal network access authentication procedure, such as IEEE 802.11i/802.1x, or PANA, by exchanging messages with AAA client NAS/DHCPv4 relay 515.

MN 105 may receive an IP address for its HA from AAA client NAS/DHCPv4 relay 515 (block 757). The IP address may be for an HA provided by a home AAA server, selected by AAA client NAS/DHCPv4 relay 515, or an address of an HA suggested by the home AAA server and selected by AAA client NAS/DHCPv4 relay 515. MN operations 750 may then terminate.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for device operation, the method comprising:
sending a request message to a server; and
receiving a reply message from the server, wherein the reply message contains an assigned Internet Protocol version 4 (IPv4) address of a home agent;
wherein the server comprises an authentication, authorization, and accounting (AAA) server;
wherein the home agent is deployed with a dual stack mobile Internet Protocol version 6 (IPv6) function.

2. The method of claim 1, wherein the request message comprises an indication that indicates that the request message is for an IPv4 address of the home agent.

3. The method of claim 1, wherein the device is a Diameter client.

4. The method of claim 3, wherein the request message comprises a Diameter-Extensible Authentication Protocol (EAP)-request message, and wherein the reply message comprises a Diameter-EAP-answer message with Mobile Internet Protocol (MIP)-Home-Agent-Address Attribute Value Pair (AVP).

5. The method of claim 4, wherein an AddressType of the MIP-Home-Agent-Address AVP is equal to one (1).

6. The method of claim 1, wherein the device is a RADIUS client.

7. The method of claim 6, wherein the request message comprises an Access-Request message, and wherein the reply message comprises an Access-Request message containing the IPv4 home agent address.

8. The method of claim 7, wherein the reply message comprises an indicator indicating an IPv4 address.

9. The method of claim 1, further comprising, sending the assigned IPv4 address of the home agent to a DHCPv4 server.

10. A method for mobile device operation, the method comprising:
sending a request message, wherein the request message contains a request for an address of a home agent; and
receiving a reply message from a Dynamic Host Configuration Protocol version 4 (DHCPv4) server, wherein the reply message contains an assigned Internet Protocol address of the home agent;
wherein the mobile device is deployed with a dual stack mobile Internet Protocol version 6 (IPv6) function.

11. The method of claim 10, wherein the address of the home agent is provided by a DHCPv4 relay.

12. The method of claim 10, further comprising:
sending a first message, wherein the first message comprises an indication of a selected DHCPv4 server and verification of the assigned IPv4 address of the home agent; and
receiving a second message from the selected DHCPv4 server, the second message comprises the assigned IPv4 address of the home agent.

13. The method of claim 12, wherein the second message further comprises network configuration information.

14. The method of claim 10, wherein the first message comprises a DHCPREQUEST message.

15. The method of claim 10, further comprising prior to the sending, initializing a network access authentication procedure.

16. An apparatus comprising:
means for sending a request message to a server; and
means for receiving a reply message from the server, wherein the reply message contains an assigned Internet Protocol version 4 (IPv4) address of a home agent;
wherein the server comprises an authentication, authorization, and accounting (AAA) server;
wherein the home agent is deployed with a dual stack mobile Internet Protocol version 6 (IPv6) function.

17. The apparatus of claim 16, further comprising means for storing the assigned IPv4 address of the home agent.

18. The apparatus of claim 17, further comprising means for sending the assigned IPv4 address of the home agent to a DHCPv4 server.

19. The apparatus of claim 18, wherein the DHCPv4 server sends the assigned IPv4 address of the home agent to the apparatus on receiving a request from the apparatus.

20. The apparatus of claim 16, wherein the AAA server is a Diameter server or a Radius server.
